(19) United States
(12) Patent Application Publication
(10) Pub. No.: US 2011/0236744 A1
(43) Pub. Date: Sep. 29, 2011

(54) FIBROUS SEPARATION MEMBRANE FOR SECONDARY BATTERY AND MANUFACTURING METHOD THEREOF

(75) Inventors: Sun Ok Kim, Seoul (KR); Young Seuck Yoo, Seoul (KR); Jin Wook Na, Gyunggi-do (KR)

(73) Assignee: SAMSUNG ELECTRO-MECHANICS CO., LTD., Gyunggi-do (KR)

(21) Appl. No.: 13/155,366

(22) Filed: Jun. 7, 2011

(30) Foreign Application Priority Data
Mar. 28, 2010 (KR) 1020110027783

(51) Int. Cl. H01M 2/16; B29C 47/06

(52) U.S. Cl. 429/144; 264/466

(57) ABSTRACT

Disclosed herein is a fibrous separation membrane for secondary batteries, comprising: a support layer containing cellulose fiber; and a first heat-resistant resin layer applied on one side of the support layer.

### CROSS REFERENCE TO RELATED APPLICATION

This application claims the benefit of Korean Patent Application No. 10-2011-0027783, filed Mar. 28, 2011, entitled “Secondary battery fibrous separation membrane and method thereof”, which is hereby incorporated by reference in its entirety into this application.

### BACKGROUND OF THE INVENTION

1. Technical Field

The present invention relates to a fibrous separation membrane for secondary batteries, and a method of manufacturing the same.

2. Description of the Related Art

A secondary battery is a battery which can be reused because it can be recharged using external energy and returned to an original state after being discharged.

Such a secondary battery is characterized in that it has high power density, it can do high-power discharge, and it is only slightly influenced by temperature.

Recently, green energy has attracted considerable attention, and thus secondary batteries have expanded their fields to IT, EV, ESS, and the like.

The demand for secondary batteries is rapidly increasing, and the function of secondary batteries is also becoming highly functionalized.

Such a secondary battery includes the four major components of a cathode active material, an anode active material, an electrolyte and a separation membrane. Among them, a separation membrane serves to separate a cathode active material and an anode active material, and is used as an ion transfer passage. As such, since a separation membrane serves to provide an ion transfer passage and prevent foreign matter from moving, it must have pores having a size of several micrometers or less.

Conventional separation membranes are mostly formed by a wet process or a dry process.

The wet process is a process of forming pores by phase-separating a solution containing a polymer, a solvent and other components and then stretching the phase-separated product, and the dry process is a process of forming pores by extruding a polymer and then stretching the extruded polymer.

Since biaxial stretching must be conducted in the wet process, the wet process is advantageous in that pores are non-oriented, but is disadvantageous in that manufacturing costs are high. In contrast, since uniaxial stretching must be conducted in the dry process, the dry process is disadvantageous in that pores are oriented, but is advantageous in that manufacturing costs are low.

All of the separation membranes formed by the wet process or the dry process are made of polyolefin-based resins. Since both the wet process and the dry process include a stretching process, there is a problem in that the raw materials of the separation membranes cannot be freely selected.

The separation membrane is generally made of two kinds of resins of polyethylene and polypropylene. The separation membrane is produced by mixing the two kinds of resins or laminating them.

Like this, since the conventional separation membrane is made of a polyolefin-based resin, its heat resistance is low, so that it is greatly constricted at high temperature, with the result that it is not suitable for EV.

Further, the conventional separation membrane is problematic in that its raw material is limited to polyolefin-based resins, so that the range of selection of raw materials is very narrow, with the result that it is not suitable for the realization of high functionality.

### SUMMARY OF THE INVENTION

Accordingly, the present invention has been devised to solve the above-mentioned problems, and the present invention intends to provide a fibrous separation membrane for secondary batteries, which can expand the range of selection of raw materials because it is manufactured by electrospinning, and which can maintain high strength because paper is used as a support layer, and a method of manufacturing the same.

An aspect of the present invention provides a fibrous separation membrane for secondary batteries, including: a support layer containing cellulose fiber; and a first heat-resistant resin layer applied on one side of the support layer.

Here, the first heat-resistant resin layer may be made of any one selected from the group consisting of aromatic polyesters, polyphosphazenes, polyurethane, polyurethane copolymers including polyetherurethane, cellulose acetate, cellulose acetate butylate, cellulose acetate propionate, polyvinylidene fluoride, perfluoropolymers, polyvinylchloride, polyvinylidene chloride, polyethyleneglycol derivatives, polyoxide, polyvinyl acetate, polystyrene, polyacrylonitrile, and polymethacrylate.

Further, the fibrous separation membrane may further include: a first polymer layer applied between the support layer and the first heat-resistant resin layer.

Further, the first polymer layer may be made of a polymer material having a melting point of 100˜180° C.

Further, the fibrous separation membrane may further include: a second heat-resistant resin layer applied on the other side of the support layer.

Further, the second heat-resistant resin layer may be made of any one selected from the group consisting of aromatic polyesters, polyphosphazenes, polyurethane, polyurethane copolymers including polyetherurethane, cellulose acetate, cellulose acetate butylate, cellulose acetate propionate, polyvinylidene fluoride, perfluoropolymers, polyvinylchloride, polyvinylidene chloride, polyethyleneglycol derivatives, polyoxide, polyvinyl acetate, polystyrene, polyacrylonitrile, and polymethacrylate.

Further, the fibrous separation membrane may further include: a second polymer layer applied between the support layer and the second heat-resistant resin layer.

Further, the second polymer layer may be made of a polymer material having a melting point of 100˜180° C.

Another aspect of the present invention provides a method of manufacturing a fibrous separation membrane for secondary batteries, including: forming a support layer containing cellulose fiber; and electrospinning a heat-resistant resin solution onto one side of the support layer to form a first ultrafine-fibrous heat-resistant resin layer.

Here, the method may further include: electrospinning a first polymer solution onto one side of the support layer to form a first ultrafine-fibrous polymer layer between the forming the support layer and the forming the first ultrafine-fibrous heat-resistant resin layer.

Further, the first polymer layer may be made of a polymer material having a melting point of 100˜180° C.

Further, the method may further include: electrospinning a heat-resistant resin solution onto the other side of the support layer to form a second ultrafine-fibrous heat-resistant resin layer.

Further, the method may further include: electrospinning a second polymer solution onto the other side of the support layer to form a second ultrafine-fibrous polymer layer between the forming the support layer and the forming the second ultrafine-fibrous heat-resistant resin layer.

Further, the second polymer layer may be made of a polymer material having a melting point of 100˜180° C.

The terms and words used in the present specification and claims should not be interpreted as being limited to typical meanings or dictionary definitions, but should be interpreted as having meanings and concepts relevant to the technical scope of the present invention based on the rule that an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a sectional view showing a fibrous separation membrane for secondary batteries according to a first embodiment of the present invention;

FIG. 2 is a sectional view showing a fibrous separation membrane for secondary batteries according to a second embodiment of the present invention;

FIG. 3 is a schematic view showing an electrospinning apparatus which can be used to manufacture the fibrous separation membrane for secondary batteries according to the present invention;

FIG. 4 is a flowchart showing a method of manufacturing the fibrous membrane for secondary batteries according to the first embodiment of the present invention; and

FIG. 5 is a scanning electron microscope (SEM) photograph showing a polymer layer formed on the surface of a support layer in the fibrous separation membrane according to the first embodiment of the present invention.

### DESCRIPTION OF THE PREFERRED EMBODIMENTS

The objects, features and advantages of the present invention will be more clearly understood from the following detailed description of preferred embodiments taken in conjunction with the accompanying drawings. Throughout the accompanying drawings, the same reference numerals are used to designate the same or similar components, and redundant descriptions thereof are omitted. Further, in the description of the present invention, when it is determined that the detailed description of the related art would obscure the gist of the present invention, the description thereof will be omitted.

Hereinafter, preferred embodiments of the present invention will be described in detail with reference to the attached drawings.

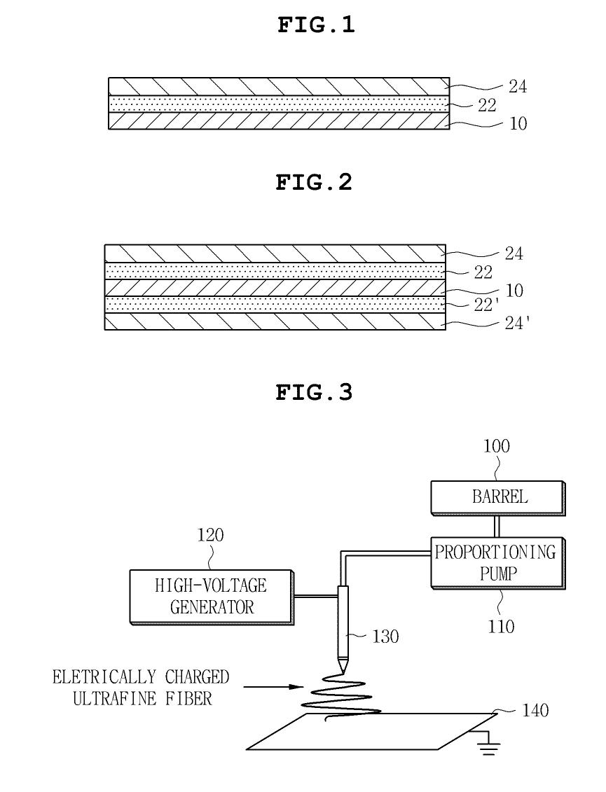

FIG. 1 is a sectional view showing a fibrous separation membrane for secondary batteries according to a first embodiment of the present invention.

As shown in FIG. 1, the fibrous separation membrane for secondary batteries according to the first embodiment of the present invention includes a support layer 10, a polymer layer 22 applied on the support layer 10, and a heat-resistant resin layer 24 applied on the polymer layer 22. Here, if necessary, the polymer layer 22 may not be provided.

The support layer 10, which serves to provide strength to the polymer layer 22 and the heat-resistance resin layer 24, is made of cellulose fiber, and has a weight of 5˜500 g/m², preferably 100-300 g/m².

Meanwhile, the support layer 10 may be formed of paper, and the paper may be transparent or translucent. In particular, the paper for forming the support layer 10 may be tracing paper. The “tracing paper” is referred to as paper certified according to ISO 4046-1978, 6.94.

Particularly, the tracing paper is obtained by hardening cellulose fiber.

Here, when paper is used as the support layer 10, pores having a size of several micrometers (μm), which is a requirement of a separation membrane, can be obtained as well guaranteeing strength.

The polymer layer 22 functions to shut down a secondary battery when the secondary battery reaches a high temperature.

The heat-resistant resin layer 24 prevents the meltdown of a separation membrane when the secondary battery is further heated after the secondary battery was shut down, thus preventing the short and explosion of the secondary battery.

The polymer layer 22 and the heat-resistant resin layer 24 may have a molecular weight which enables electrospinning to be carried out, and, particularly, may have a molecular weight of 10,000 or more. When the polymer layer 22 and the heat-resistant resin layer 24 have a molecular weight of 10,000 or more, fiber can be easily made by electrospinning, and the physical properties thereof are excellent. Further, as the molecular weight thereof increases, the diameter of the nanofiber obtained by electrospinning decreases, thus forming a large number of junctions of nanofibers.

Further, the polymer layer 22 and the heat-resistant resin layer 24 can be made of a polymer having a molecular weight of 2,000 or more in terms of workability and physical properties depending on mass production. In particularly, the polymer layer 22 and the heat-resistant resin layer 24 can be made of ultra-high molecular weight polyethylene having a molecular weight of 1,000,000˜5,000,000.

If the solvent used to form the polymer layer 22 and the heat-resistant resin layer 24 can suitably dissolve a polymer and disperse solid particles, the solvent may be selectively used depending on the kind of polymer and solid particles by those skilled in the art.

The polymer layer 22 is made of a polyolefin resin or a polymer having a melt index of 1˜25 g/min and a relatively low melting point, such as polyethylene (PE), polypropylene (PP), polymethylpentene, an ethylene-propylene copolymer or the like.

Further, for the purpose of shutdown function, the polymer layer 22 may be made of a polymer material having a melting point of 100˜180° C., preferably 120˜150° C.

Here, a polyolefin resin or a polymer is used to make the polymer layer 22, but the present invention is not limited thereto. All of the polymer materials having a melting point of 100˜180° C. can be used.

The heat-resistant resin layer is made of a polymer having a melting point of 180° C. or having no melting point. Examples of the polymer having a melting point of 180° C. or having no melting point may include: aromatic polyesters, such as polyamide, polyimide, polyamideimide, poly(meta-phenyleneisophthalamide), polysulfone, polyether ketone, polyether imide, polyethylene terephthalate, polytrimethylene terephthalate, polyethylene naphthalate, and the like; polyphosphazenes, such as polytetrafluoroethylene, polydiphenoxyphosphazene, poly{bis[2-(2-methoxyethoxy)phosphazene]}, and the like; polyurethane; polyurethane copolymers, such as polyetherurethane, and the like; cellulose acetate; cellulose acetate butylate; cellulose acetate propionate; polyvinylidene fluoride; perfluoropolymers; polyvinylchloride; polyvinylidene chloride; polyethyleneglycol derivatives; polyoxide; polyvinyl acetate; polystyrene; polyacrylonitrile; polymethacrylate; and the like.

Here, the polymer having no melting point is referred to as a polymer that burns without melting even at 180° C. or higher.

Both the polymer layer 22 and the heat-resistant resin layer 24 may have a thickness of 1˜50 μm, preferably 1˜20 μm, more preferably 5˜10 μm. When the thickness thereof is excessively small, sufficient effects cannot be exhibited. Further, when the thickness thereof is excessively large, it is economically disadvantageous and is not especially profitable.

As described above, the fibrous separation membrane for secondary batteries is formed by sequentially electrospinning a polymer solution (including a melt solution) onto the support layer 10, and is formed therein with pores that are micrometers in size.

It was ascertained that the matrix of the fibrous separation membrane for secondary batteries has a structure in which ultrafine polymer fibers having a diameter of 1˜3000 nm are irregularly and three-dimensionally laminated, so that the ratio of surface area to volume of the matrix thereof is higher than that of a conventional matrix, and the porosity thereof is higher than that of the conventional matrix.

Therefore, since the porosity of the matrix of the separation membrane is high, the amount of an electrolyte impregnated into the matrix thereof increases, thus increasing the ion conductivity of the separation membrane. Further, since the surface area of the matrix of the separation membrane is large regardless of the high porosity thereof, the contact area of an electrolyte to the matrix of the separation membrane can be increased, thus minimizing the leakage of the electrolyte.

Meanwhile, when a porous polymer matrix is formed by electrospinning, there is an advantage in that the porous polymer matrix is directly formed in the form of membrane.

The diameter of the fibrous polymer forming the porous polymer matrix may be adjusted to within a range of 1˜3000 nm, preferably 10˜1000 nm, more preferably 50˜500 nm. When the diameter of the fibrous polymer is excessively small, it is difficult to form a separation membrane. Further, when the diameter thereof is excessively large, the impregnation rate of an electrolyte is decreased.

Further, the porosity of the polymer layer 22 applied on the support layer 10 is about 20˜90%, and the pore size thereof is about 10 nm˜10 μm.

FIG. 2 is a sectional view showing a fibrous separation membrane for secondary batteries according to a second embodiment of the present invention.

As shown in FIG. 2, the fibrous separation membrane for secondary batteries according to the second embodiment of the present invention includes a support layer 10, a pair of polymer layers 22 and 22′ applied on both sides of the support layer 10, and a pair of heat-resistant resin layers 24 and 24′ respectively applied on the polymer layers 22 and 22′. Here, if necessary, the polymer layers 22 and 22′ may not be provided.

The configuration of the fibrous separation membrane for secondary batteries according to the second embodiment of the present invention is the same as that of the fibrous separation membrane for secondary batteries according to the first embodiment of the present invention, except that the polymer layers 22 and 22′ and the heat-resistant resin layers 24 and 24′ are sequentially formed on both sides of the support layer 10. Therefore, detailed descriptions thereof will be omitted.

Hereinafter, a method of manufacturing the fibrous membrane for secondary batteries according to the first embodiment will be described with reference to FIG. 3.

FIG. 3 is a schematic view showing an electrospinning apparatus which can be used to manufacture the fibrous separation membrane for secondary batteries according to the present invention.

As shown in FIG. 3, the electrospinning apparatus includes a barrel 100 for storing a polymer solution or a heat-resistant resin solution, a proportioning pump 110 for discharging the polymer solution or heat-resistant resin solution, a high-voltage generator 120, and a spinning nozzle 130 connected to the high-voltage generator 120.

The polymer solution or heat-resistant resin solution discharged through the proportioning pump 110 passes through the spinning nozzle 130 electrically charged by the high-voltage generator 120 to be formed into ultrafine fiber, and the ultrafine fiber is collected on the support layer 10 disposed on a collecting plate 140 grounded in the form of a conveyor moving at a predetermined speed.

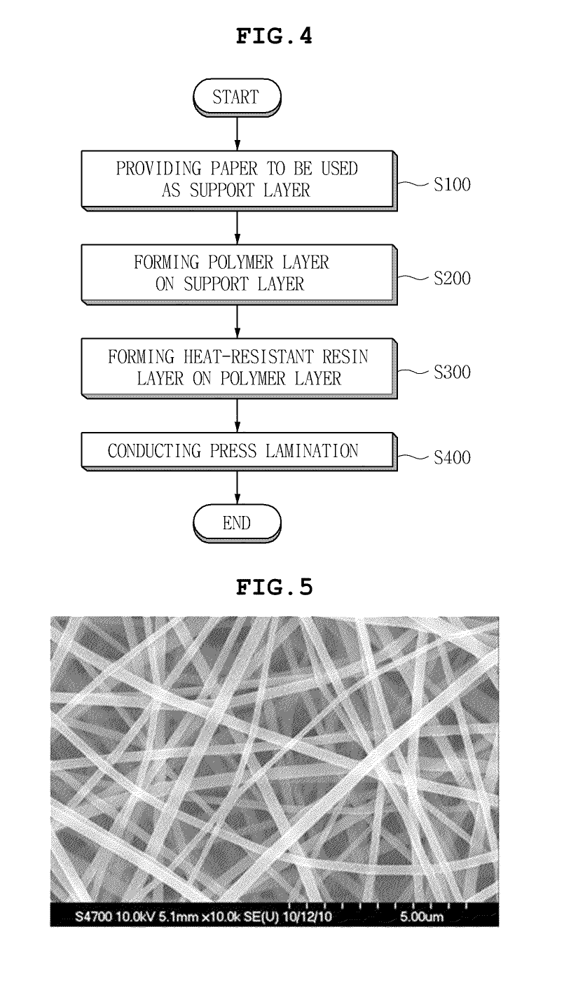

FIG. 4 is a flowchart showing a method of manufacturing the fibrous membrane for secondary batteries according to the first embodiment.

As shown in FIG. 4, in the method of manufacturing the fibrous membrane for secondary batteries according to the first embodiment, first, paper to be used as a support layer is prepared and provided (S100).

The paper is made of cellulose fiber, and has a weight of 5˜500 g/m², preferably 100˜300 g/m². In particular, the paper is a tracing paper obtained by hardening cellulose fiber.

Subsequently, a polymer solution is put into a barrel of an electrospinning apparatus, the polymer solution is discharged using a proportioning pump, and then a spinning nozzle is electrically charged using a high-voltage generator, thus forming a polymer layer on the paper disposed on a collecting plate grounded in the form of a conveyor moving at a predetermined speed (S200).

For example, as the polymer solution, a polyethylene (PE) solution is prepared and then put into a barrel of an electrospinning apparatus, and then the polyethylene (PE) solution is discharged using a proportioning pump.

In this case, a spinning nozzle is electrically charged using a high-voltage generator to form a polymer layer having a thickness of 50 μm on a support layer.

Here, if necessary, the procedure of forming the polymer layer may be omitted.

Subsequently, a heat-resistant resin solution, for example a polyethylene terephthalate (PET) solution, is electrospun in the same manner as the polymer solution to form a heat-resistant resin layer on the polymer layer, thereby manufacturing an ultrafine-fibrous porous polymer separation membrane (S300).

FIG. 5 shows a scanning electron microscope (SEM) photograph of the polymer layer applied on the surface of the support layer.

Subsequently, in order to increase adhesion between the support layer and the polymer layer and adhesion between the polymer layer and the heat-resistant resin layer and to adjust the porosity and thickness of the heat-resistant resin layer, press lamination is conducted at a predetermined temperature or lower after the polymer layer is disposed on the support layer, or is conducted at a predetermined temperature or lower after the separation membrane of the present invention is disposed between a cathode and an anode (S400).

Meanwhile, in a method of manufacturing the fibrous membrane for secondary batteries according to the second embodiment of the present invention, a pair of polymer layers 22 and 22′ and a pair of heat-resistant resin layers 24 and 24′ can be sequentially formed on both sides of a support layer in the same manner as the above-mentioned method of manufacturing the fibrous membrane for secondary batteries according to the first embodiment of the present invention. Therefore, detailed descriptions thereof will be omitted.

Here, if necessary, the procedure of forming the pair of polymer layers 22 and 22′ may be omitted.

As described above, according to the present invention, a separation membrane can assure sufficient strength because it is manufactured by electrospinning a polymer solution on paper used as a support layer.

Further, according to the present invention, micropores can be formed in a separation membrane because the separation membrane is manufactured by electrospinning a polymer solution on paper used as a support layer.

Further, according to the present invention, a separation membrane having heat resistance, which is not constricted even at high temperature, can be obtained because paper and several polymer resins are used.

Further, according to the present invention, owing to the post-treatment using a thermal pressing process, the adhesion between the fiber and the paper can be improved, the strength of a separation membrane can be improved, and a thin fibrous separation membrane can be obtained.

Furthermore, according to the present invention, a thin separation membrane can be obtained, so that a secondary battery generates high power, thereby improving the performance of a secondary battery.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A fibrous separation membrane for secondary batteries, comprising:
a support layer containing cellulose fiber; and
a first heat-resistant resin layer applied on one side of the support layer.

2. The fibrous separation membrane for secondary batteries according to claim 1, wherein the first heat-resistant resin layer is made of any one selected from the group consisting of aromatic polyesters, polyphosphazenes, polyurethane, polyurethane copolymers including polyetherurethane, cellulose acetate, cellulose acetate butylate, cellulose acetate propionate, polyvinylidene fluoride, perfluoropolymers, polyvinylchloride, polyvinylidene chloride, polyethyleneglycol derivatives, polyoxide, polyvinyl acetate, polystyrene, polyacrylonitrile, and polymethacrylate.

3. The fibrous separation membrane for secondary batteries according to claim 1, further comprising: a first polymer layer applied between the support layer and the first heat-resistant resin layer.

4. The fibrous separation membrane for secondary batteries according to claim 3, wherein the first polymer layer is made of a polymer material having a melting point of 100˜180° C.

5. The fibrous separation membrane for secondary batteries according to claim 1, further comprising: a second heat-resistant resin layer applied on the other side of the support layer.

6. The fibrous separation membrane for secondary batteries according to claim 5, wherein the second heat-resistant resin layer is made of any one selected from the group consisting of aromatic polyesters, polyphosphazenes, polyurethane, polyurethane copolymers including polyetherurethane, cellulose acetate, cellulose acetate butylate, cellulose acetate propionate, polyvinylidene fluoride, perfluoropolymers, polyvinylchloride, polyvinylidene chloride, polyethyleneglycol derivatives, polyoxide, polyvinyl acetate, polystyrene, polyacrylonitrile, and polymethacrylate.

7. The fibrous separation membrane for secondary batteries according to claim 5, further comprising: a second polymer layer applied between the support layer and the second heat-resistant resin layer.

8. The fibrous separation membrane for secondary batteries according to claim 7, wherein the second polymer layer is made of a polymer material having a melting point of 100˜180° C.

9. A method of manufacturing a fibrous separation membrane for secondary batteries, comprising:
forming a support layer containing cellulose fiber; and
electrospinning a heat-resistant resin solution onto one side of the support layer to form a first ultrafine-fibrous heat-resistant resin layer.

10. The method according to claim 9, further comprising: electrospinning a first polymer solution onto one side of the support layer to form a first ultrafine-fibrous polymer layer between the forming the support layer and the forming the first ultrafine-fibrous heat-resistant resin layer.

11. The method according to claim 10, wherein the first polymer layer is made of a polymer material having a melting point of 100˜180° C.

12. The method according to claim 9, further comprising: electrospinning a heat-resistant resin solution onto the other side of the support layer to form a second ultrafine-fibrous heat-resistant resin layer.

13. The method according to claim 12, further comprising: electrospinning a second polymer solution onto the other side of the support layer to form a second ultrafine-fibrous polymer layer between the forming the support layer and the forming the second ultrafine-fibrous heat-resistant resin layer.

14. The method according to claim 13, wherein the second polymer layer is made of a polymer material having a melting point of 100˜180° C.
